(19) United States
(12) Patent Application Publication
(10) Pub. No.: US 2026/0164228 A1
(43) Pub. Date: Jun. 11, 2026

(54) EMBEDDED SUBSCRIBER IDENTITY MODULE DELETION

(71) Applicant: T-MOBILE INNOVATIONS LLC, Overland Park, KS (US)

(72) Inventors: Kyeong Hun AN, Sammamish, WA (US); Nilesh RANJAN, Sammamish, WA (US); Anthony YIU, Newcastle, WA (US)

(21) Appl. No.: 18/977,364

(22) Filed: Dec. 11, 2024

(51) Int. Cl. H04W 8/18

(52) U.S. Cl. CPC H04W 8/18

(57) ABSTRACT

Embodiments of the present disclosure are directed to systems and methods for managing embedded subscriber identity module (eSIM) profiles on user equipment (UE) within a mobile communication network. The disclosed mechanisms facilitate the automatic identification and management of inactive eSIM profiles based on subscription status, billing activity, or service usage.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, methods and systems are provided for managing embedded subscriber identity module (eSIM) profiles on user equipment (UE) through automation. More particularly, this disclosure provides methods and systems for utilizing a device application to periodically assess the subscription status of eSIM profiles. Based on the assessment, appropriate actions are taken to enhance the efficiency of eSIM utilization.

### BRIEF DESCRIPTION OF THE DRAWINGS

Implementations of the present disclosure are described in detail below with reference to the attached drawing figures, wherein:

FIG. 1 illustrates an exemplary computing device for use with the present disclosure;

FIG. 2 illustrates a diagram of an exemplary network environment in which implementations of the present disclosure may be employed;

FIG. 3 illustrates a flow diagram of a method for managing embedded subscriber identity module (eSIM) profiles on a UE; and

FIG. 4 illustrates a flow diagram of a method for managing eSIM profiles on a UE, for use with the present disclosure.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, embedded subscriber identity module (eSIM) chips are embedded directly into the UE's motherboard. eSIMs facilitate the scalability of Internet of Things (IoT) applications by enabling seamless remote provisioning and over-the-air management, simplifying the activation process for connected devices. They enhance security, as they are embedded and less prone to tampering compared to physical SIMs, while also allowing for easy updates and network changes. Additionally, eSIMs let users switch carriers and manage mobile plans digitally without the need for physical SIM card swaps. This digital management offers space-saving designs, improved security, and the ability to store multiple carrier profiles on a single device. However, managing eSIM profiles efficiently on the network side remains a challenge, particularly when users discontinue their subscriptions.

Conventionally, managing inactive eSIM profiles involves manual processes where users must delete the inactive eSIM profiles from their devices. As this approach relies heavily on user intervention, it can be inconsistent and unreliable. Moreover, many users neglect to delete their eSIM profiles after their subscriptions become inactive, leading to profiles remaining tied to devices unnecessarily. This not only prevents the reuse of eSIM profiles but also results in inefficient resource management for mobile network operators.

In contrast to conventional solutions, the proposed solution addresses these challenges by automating the management of eSIM profiles. The methods and systems described herein periodically assess the subscription status of eSIM profiles. For example, if an eSIM profile is found to be inactive, the network automatically instructs the UE to delete the profile and send a deletion notification to an eSIM management platform. The unassigned eSIM profile is then reassigned to a new UE. This automated approach ensures efficient utilization of eSIM profiles, improves network efficiency, enhances security, and optimizes the overall management process for mobile network operators, leading to significant economic benefits. Additionally, by removing inactive profiles, this approach also frees up storage space on the UE.

Accordingly, a first aspect of the present disclosure provides a method for managing embedded subscriber identity module (eSIM) profiles on user equipment (UE). This method comprises querying a data repository to determine the subscription status of an eSIM profile associated with the UE. Upon determining that the eSIM profile is inactive, the method automatically instructs the UE to delete the eSIM profile. The method further comprises receiving a deletion notification from the UE indicating that the eSIM profile has been deleted and updating the status of the eSIM profile to an unassigned status. Additionally, the method includes assigning the eSIM profile to a second UE.

In a second aspect of the present disclosure, a system is provided for managing embedded subscriber identity module (eSIM) profiles on user equipment (UE). This system comprises one or more antennas, one or more processors, and one or more computer-readable media storing computer-usable instructions. When executed by the processors, these instructions cause the system to communicate, via a signal transmitted from the antennas, an indication that an eSIM profile associated with the UE is inactive. The system then receives instructions to delete the eSIM profile, proceeds to delete the profile, and sends a deletion notification to an eSIM management platform.

A third aspect of the present disclosure is directed to a method for managing eSIM profiles on user equipment (UE). This method comprises querying a data repository to determine the subscription status of an eSIM profile stored on the UE. Upon determining that the subscription status is inactive, the method automatically deletes the eSIM profile from the UE and sends a notification from the UE to an eSIM management platform.

A fourth aspect of the present disclosure is directed to a system for managing eSIM profiles on user equipment (UE). This system comprises a monitoring module, a deletion module, a notification module, one or more processors, and one or more computer-readable media storing computer-usable instructions. When executed by the processors, these instructions cause the system to check the subscription status of an eSIM profile stored on a UE and determine that the eSIM profile is inactive based on predefined criteria via the monitoring module. The system also automatically deletes the eSIM profile from the UE via the deletion module, and sends a deletion notification to an eSIM management platform via the notification module. The system also updates the status of the eSIM profile to an inactive status.

Another aspect of the present disclosure is directed to a non-transitory computer-readable medium having instructions stored thereon that, when executed by one or more computer processing components, cause the one or more computer processing components to perform a method. This method comprises querying a data repository to determine the subscription status of an eSIM profile associated with a user equipment (UE). Upon determining that the eSIM profile is inactive, the method automatically instructs the UE to delete the eSIM profile. The method further includes receiving a deletion notification from the UE indicating that the eSIM profile has been deleted and updating the status of the eSIM profile to an unassigned status. Additionally, the method involves assigning the eSIM profile to a second UE.

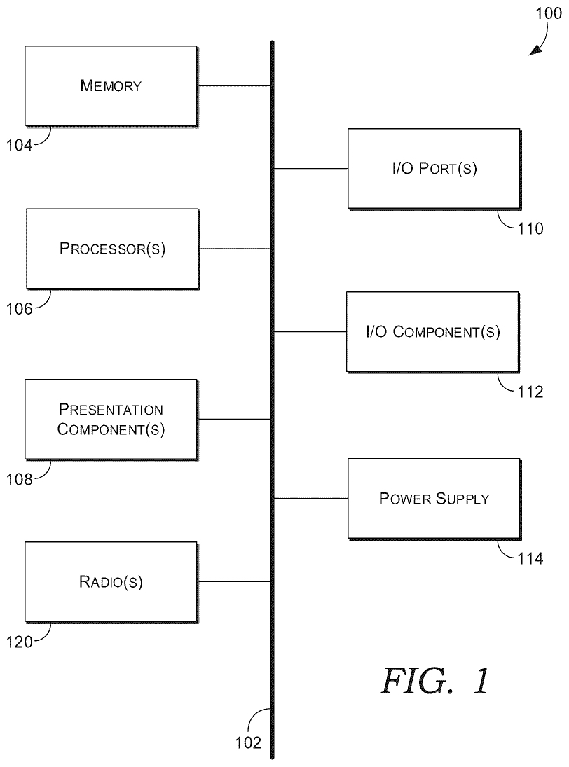

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device. The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, one or more input/output (I/O) ports 110, one or more I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of the one or more I/O components 112. Also, processors, such as the one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as the bus 102, the memory 104 or the one or more I/O components 112. The one or more presentation components 108 presents data indications to a person or other device. Exemplary one or more presentation components 108 include a display device, speaker, printing component, vibrating component, etc. The one or more I/O ports 110 allow computing device 100 to be logically coupled to other devices including the one or more I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, 6G, or other VoIP communications. As can be appreciated, in various embodiments, the radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

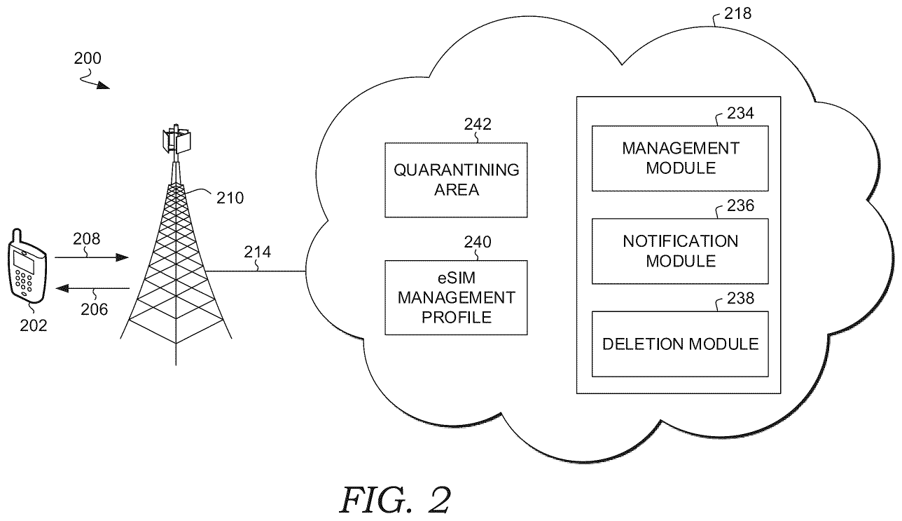

Referring now to FIG. 2, a representative network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment 200 be interpreted as having any dependency or requirement relating to any one or combination of components illustrated.

Network environment 200 represents a high level and simplified view of relevant portions of one or more modern wireless telecommunication networks. At a high level, the network environment 200 may generally be said to comprise one or more UEs, such as a UE 202, one or more base stations, such as a base station 210, and a core network 218, though in some implementations, it may not be necessary for certain features to be present. Similarly, while each component is shown in the singular, it is expressly contemplated that there may be more than one of the components described. The network environment may include a number of routers, switches, and the like. The network environment 200 is generally configured for wirelessly connecting the UE 202 to data or services that may be accessible on one or more application servers or other functions, nodes, or servers not pictured in FIG. 2 so as to not obscure the focus on the present disclosure.

The network environment 200 comprises the UE 202. The UE 202 is illustrated generally, and may take any number of forms, including a tablet, phone, or wearable device, or any other device discussed with respect to FIG. 1 and may have any one or more components or features of the computing device 100 of FIG. 1. In aspects, the UE 202 may not be a conventional telecommunications devices (i.e., a device that is capable of placing and receiving voice calls), but may instead take the form of devices that only utilizes wireless network resources in order to transmit or receive data; such devices may include IoT devices (e.g., smart appliances, thermostats, locks, smart speakers, lighting devices, smart receptacles, and the like).

The network environment 200 comprises one or more of the base station 210 to which the UE 202 may potentially connect to (also referred to as ‘camping on,’ ‘attaching,’ in the industry). Though network environment 200 is illustrated with one base station 210, one skilled in the art will appreciate that more or fewer base stations may be present in any particular network environment. The base station 210 of the network environment 200 is configured to wirelessly communicate with UEs, such as the UE 202. In aspects, the base station 210 may communicate with the UE 202 using any wireless telecommunication protocol desired by a network operator, including but not limited to 2G, 3G, 4G, 5G, 6G, 802.11x and the like.

The base station 210 may communicate signals to one or more UEs via a downlink 206 and receive signals from one or more UEs via uplink 208. In response to receiving certain requests to and/or from the UE 202, the base station 210 may communicate with the core network 218 via a backhaul 214. For example, in order for the UE 202 to connect to a desired network service (e.g., PSTN call, voice over LTE (VoLTE) call, voice over new radio (VoNR), data, or the like), the UE 202 may communicate an attach request to the base station 210, which may, in response, communicate a registration request to the core network 218 via the backhaul 214.

The core network 218 may comprise one or more network functions (NFs). As used herein, the term “network function” refers to a computer processing module and/or one or more computer-executable services being executed on one or more computing processing modules. NFs within the core network 218 are defined by their function, as the core network 218 is a service-based architecture. The core network 218 may comprise NFs that include any one or more of a management module 234, a notification module 236, a deletion module 238, an eSIM management profile 240, and a quarantining area 242. These NFs may communicate with each other, directly or indirectly, via interfaces existing between them. Each of the preceding NFs may take different forms, including consolidated or distributed forms that perform the same general operations. In other architectures or protocols, the NFs may be given other names; however, the NFs herein refer to functions, not specifically identified components.

Though the management module 234, notification module 236, deletion module 238, eSIM management profile 240, and quarantining area 242 are illustrated in the core network 218, the core network 218 may have more or fewer NFs than shown. Further, though these modules are illustrated as disposed within the core network 218, it is expressly contemplated that the location in the network environment 200 is non-limiting. For example, these NFs may be disposed between the base station 210 and the core network 218 (i.e., the network edge) or may be isolated as stand-alone components, or a combination of these. While each of the NFs described above are illustrated in the singular, it is expressly contemplated that the network environment 200 may include one or more of each of the NFs described above.

The management module 234 may function as a central processing unit for overseeing the activity status of eSIMs on UE 202. The management module 234 is configured to query data repositories periodically or at a predetermined frequency, or in predetermined intervals (e.g., daily, weekly, monthly), to assess the subscription status of eSIM profiles, and to coordinate with other NFs. The management module 234 may actively process data to make decisions about whether an eSIM profile is inactive and requires action. In aspects, the management module 234 may identify an eSIM profile as inactive based on usage data (e.g., if it has not exhibited data transmission, voice call, or messaging activity over a defined monitoring period). In other aspects, the management module 234 may identify an eSIM profile as inactive based on its billing status. More specifically, if the eSIM profile is not associated with an active billing account or if there is an indication that billing has ceased (e.g., non-payment or cancellation of the subscription), the management module 234 may classify the eSIM profile as inactive. For example, when a user terminates their service plan or a billing account is suspended due to non-payment, the associated eSIM profile may be flagged as inactive, as it no longer has authorization for network service. In alternative aspects, the UE 202 may communicate, via a signal transmitted from one or more antennas, an indication that the eSIM profile associated with the UE 202 is inactive.

Upon determining an eSIM profile as inactive, the notification module 236 may be prompted to issue a first notification to the UE 202. This notification may inform a user associated with the UE 202 of the inactivity status and provide a prompt to take action to maintain or reactivate the eSIM profile. For example, if an eSIM profile linked to a travel plan is flagged as inactive, the notification may serve as a reminder to the user to extend or reactivate their service. In other words, the notification module 236 ensures that users are aware of pending actions and have the opportunity to prevent automatic deletion of their eSIM profile.

If no response is received from the user within a predetermined timeframe (e.g., a first amount of time) following the first notification, the deletion module 238 may initiate the deletion process for the inactive eSIM profile. The deletion module 238 interfaces with the UE 202 to automatically transmit deletion instructions and may incorporate encryption protocols to secure the eSIM profile data before deletion. For example, if the user does not respond to the inactivity alert within a predetermined amount of time, the deletion module 238 may instruct the UE 202 to delete the eSIM profile, thereby freeing up network resources. Once the UE 202 has successfully deleted the eSIM profile, the UE 202 may send a deletion notification to the eSIM management profile 240. The eSIM management profile 240 may then update the eSIM's profile status to “unassigned” in the network 218 database.

In alternative aspects, if the user of the UE 202 responds to the inactivity alert or resumes a service associated with the eSIM profile within the first amount of time following the first notification described above, the eSIM profile may not be deleted.

The quarantining area 242 may serve as an intermediate holding environment for eSIM profiles marked for deletion. The eSIM profile may be quarantined for a first predetermined period before deletion and for a second predetermined period immediately after deletion. The quarantining area 242 allows for a grace period during which an eSIM profile may be reinstated if the associated user resumes relevant service activity. For example, if UE 202 initiates activity related to the eSIM during the quarantine period, the management module 234 may coordinate with the deletion module 238 to halt the deletion process and restore the profile on the UE 202. After the quarantine period, the eSIM profiles are stored in the eSIM management profile 240, where inactive profiles are maintained after deletion. These profiles can then be assigned to new UEs, such as a second UE (not shown).

The eSIM management profile 240 is a data repository configured to store and maintain comprehensive information about the lifecycle of each eSIM profile, including activation status, historical usage metrics, and subscription details. The eSIM management profile 240 serves as a reference point for the management module 234 during periodic checks and decision-making processes to determine activity levels and verify whether an eSIM profile requires further action. For example, an eSIM profile with seasonal usage history may be flagged with consideration for its typical activity patterns to avoid premature deactivation or deletion.

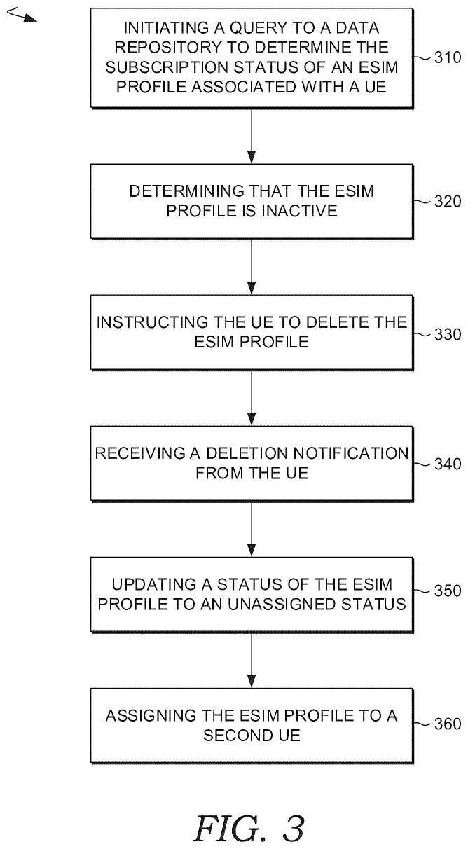

Turning now to FIG. 3, a flow chart illustrates aspects of a method 300 for managing embedded subscriber identity module (eSIM) profiles. The method 300 begins at block 310 with the management module, such as management module 234 described with respect to FIG. 2, initiating a query to a data repository to determine the subscription status of an eSIM profile associated with the UE. The data repository, which may include the eSIM management profile 240 described with respect to FIG. 2, stores comprehensive records of subscription activity, including billing and service status for each eSIM profile. The management module is configured to actively query this data and conduct periodic checks (e.g., daily, weekly, monthly) and/or respond to network events that necessitate an assessment of the eSIM's billing and service status. For example, when the network detects billing inactivity or no current transactions, the management module may trigger an assessment.

At block 320, the management module processes and analyzes the data retrieved from the eSIM management profile to determine whether the eSIM profile is inactive. This may comprise evaluating attributes such as non-payment history or account suspension indicators. If the billing data or usage patterns reveal a halt in service or subscription termination, the management module may classify the profile as inactive or vacant, prompting further action.

Once the management module has confirmed that the eSIM profile is inactive, block 330 comprises generating a secure instruction from the network for the UE to delete the eSIM profile. The deletion module is tasked with creating and transmitting this command, ensuring that the profile data is encrypted and then removed from the UE in accordance with security protocols.

At block 340, the network may receive a notification from the UE confirming that the eSIM profile has been deleted. In aspects, this deletion notification is transmitted through secure communication channels. At block 350, the deletion notification may prompt the management module to update the status of the profile in the eSIM management profile, marking it as “unassigned” or “deleted.”

At block 360, the method may include a process for reallocating the unassigned eSIM profile to a second UE. The management module is configured to oversee this reallocation by responding to service requests and assigning the unassigned profile to a different device (e.g., a second UE, not shown in FIG. 2).

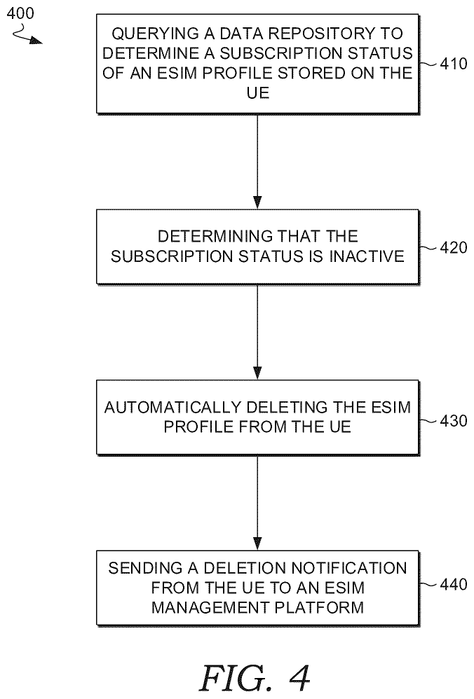

Referring now to FIG. 4, a flow chart illustrates aspects of a method 400 for a UE to manage its eSIM profile. The process begins at block 410, where the UE queries its internal data repository to determine the current subscription status of its eSIM profile. This data repository may include synchronized information from the network, such as billing and subscription status stored in the eSIM management profile. At block 420, the UE may identify that the billing account associated with the eSIM profile is inactive, prompting it to flag the profile for further action.

At block 430, the UE may initiate the automatic deletion of the inactive eSIM profile. This step involves secure data removal processes, which may include encrypting the eSIM profile data before deletion to ensure data protection and prevent unauthorized recovery. Once the deletion is completed, block 440 comprises the UE sending a deletion notification to the network's eSIM management profile to report the successful deletion of the eSIM profile. This notification is transmitted through secure channels, ensuring the integrity of the communication. The network, upon receiving the deletion notification, may update the eSIM management profile to reflect the profile's status as “deleted” or “unassigned.”

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for managing embedded subscriber identity module (eSIM) profiles on a user equipment (UE), comprising:
querying a data repository to determine a subscription status of an eSIM profile associated with the UE;
determining that the eSIM profile is inactive; and
based on the eSIM profile being inactive, automatically instructing the UE to delete the eSIM profile.

2. The method of claim 1, wherein a first notification is communicated to the UE prior to automatically instructing the UE to delete the eSIM profile.

3. The method of claim 2, wherein automatically instructing the UE to delete the eSIM profile occurs at a first amount of time after the first notification is communicated to the UE.

4. The method of claim 1, wherein the querying is performed at a predetermined frequency.

5. The method of claim 1, further comprising: receiving a deletion notification from the UE indicating that the eSIM profile has been deleted; and updating a status of the eSIM profile to an unassigned status.

6. The method of claim 5, further comprising assigning the eSIM profile to a second UE.

7. The method of claim 6, wherein the eSIM profile is assigned to the second UE after quarantining for a predetermined amount of time.

8. The method of claim 1, further comprising encrypting the eSIM profile before deletion.

9. A system for managing embedded subscriber identity module (eSIM) profiles on a user equipment (UE), the system comprising:
one or more antennas;
one or more processors; and
one or more computer-readable media storing computer-usable instructions that, when executed by the one or more processors, cause the UE to:
communicate, via a signal transmitted from the one or more antennas, an indication that an eSIM profile associated with the UE is inactive;
receive instructions to delete the eSIM profile;
delete the eSIM profile; and
send a deletion notification to an eSIM management profile.

10. The system of claim 9, wherein a first notification is communicated to a user of the UE prior to the UE deleting the eSIM profile.

11. The system of claim 10, wherein the UE deletes the eSIM profile after a predetermined amount of time following a receipt of the first notification.

12. The system of claim 11, further comprising quarantining the eSIM profile for a predetermined quarantine period prior to deletion.

13. The system of claim 12, further comprising restoring the eSIM profile on the UE if the user resumes a service associated with the eSIM profile during the predetermined quarantine period.

14. The system of claim 9, further comprising encrypting the eSIM profile before deletion.

15. A method for managing eSIM profiles on a user equipment (UE), comprising:
querying a data repository to determine a subscription status of an eSIM profile stored on the UE;
determining that the subscription status is inactive;
automatically deleting the eSIM profile from the UE; and
sending a deletion notification from the UE to an eSIM management platform.

16. The method of claim 15, further comprising receiving a confirmation from the eSIM management platform that the eSIM profile has been marked as inactive.

17. The method of claim 15, further comprising quarantining the eSIM profile for a predetermined quarantine period prior to deletion.

18. The method of claim 17, further comprising restoring the eSIM profile on the UE if a user resumes a service associated with the eSIM profile during the predetermined quarantine period.

19. The method of claim 15, further comprising encrypting the eSIM profile before deletion.

20. The method of claim 15, wherein the UE automatically deletes the eSIM profile after the eSIM profile remains inactive for a predetermined number of consecutive status checks.
